(19) United States
(12) Patent Application Publication
(10) Pub. No.: US 2022/0063848 A1
(43) Pub. Date: Mar. 3, 2022

(54) MANUFACTURING PROCESS FOR PRODUCING HERMETIC SINGLE-USE FOOD CONTAINERS USING A SEALING HEAD HAVING A SPECIFIC PROFILE WITH A RIB

(71) Applicant: SOCIETE DES PRODUITS NESTLE S.A., Vevey (CH)

(72) Inventors: Nicolas Gres, Echenevex (FR); Christophe Sebastien Paul Heydel, Chez-Le-Bart (CH); Pierre Nicolas Neyret, Orbe (CH); Alexandre Kollep, Lutry (CH)

(21) Appl. No.: 17/415,033

(22) PCT Filed: Dec. 17, 2019
(86) PCT No.: PCT/EP2019/085488

§ 371 Date: Jun. 17, 2021

(30) Foreign Application Priority Data
Dec. 19, 2018 (EP) 18213847.9

(51) Int. Cl. B65B 7/28; B31F 1/00; B65D 77/20; B65D 85/804

(52) U.S. Cl. CPC B65B 7/2878; B31F 1/0083; B65D 2577/2025; B65D 77/2024; B65D 85/8046; B31F 1/0077

(57) ABSTRACT

The invention concerns a manufacturing process for producing hermetic single-use food containers, including: forming a container body (30) having an peripheral rim (31), placing the container body in a sealing head having a first die (2) and a second die (8) having cooperating annular sealing surfaces (4, 10) facing the rim (31), sealing a closing lid (34) placed over the container body with the rim (31) by applying the first die (2) and the second die (8) one against the other. According to the invention, the first die (2) is provided with a continuous annular rib (6) in its sealing surface (4), the rib having a height (h) which is at least equal to a maximum depth of wrinkles that might appear on the rim upon forming the container body, whereby a sealing groove (12) is formed by the rib (6) in a side of the rim during the sealing.

### FIELD OF THE INVENTION

The invention deals with containers, more particularly with single-use containers hermetically closed by a lid film or other top designed to minimize airflow or vapor flow into the container. Such containers are used for foodstuff, such as the coffee pods to be used in beverage system.

Single-use containers hermetically closed by a lid film are well known. Such containers usually include:
a container body having a sidewall or sidewalls and a rim extending outwardly from the top of the sidewall(s),
and a lid film or analogous that closes the top of the container body by being sealed with the rim.

### BACKGROUND OF THE INVENTION

Some known container bodies are made from a laminated material including a plastic barrier.

On the one hand, single-use plastic barrier containers already in the market exhibits good sealing between the container body and the lid thanks to plastic stretchability, which is around 600%. The rim of the plastic thermoformed/injected container body has a flat surface and a constant thickness. The sealing of the lid onto the rim of such container bodies is therefore strong.

On the other hand, consumers seek for more eco-friendly and environment-friendly packaging materials, with “natural” appealing aspects.

PLA laminate (like PLA/PVOH/PLA, where PLA means polylactic acid and PVOH means polyvinyl alcohol) is compostable, while paper provides a “natural” feeling. Therefore, a single-use container body made of Paper/PLA laminate would answer to consumers' concerns. The heat-sealing is done by the PLA plastic material.

Unfortunately, paper stretchability is around 10%. Thus, for container bodies made from such material with paper, when the flat paper is formed in a three-dimensional shape, wrinkles (up to 1 mm) appear at the surface of the container rim. Therefore, channels are created between the container body and the closing lid or between the layers of the paper-laminated material. Such channels allow for gas and vapor (moisture) to enter the container, which is detrimental to the quality of the ingredient contained therein, after storage periods. During heat-sealing with usual heat-sealing heads, the wrinkles remain in some extend and sealing is not ensured in the wrinkles. Thus, even though a partially effective seal may be created, the container contents are nonetheless exposed to some amount of external air and moisture seeping through these wrinkles. This in turn accelerates the spoiling of the container's content. Oxygen and vapor barrier properties in the rim are insufficiently obtained.

A known solution is to add a plastic rim to ensure smooth and regular rim surface. Such containers with encapsulated rim features are disclosed by EP1485178. Indeed, EP1485178 proposes various container bodies having fully or partially-encapsulated rim or flange. The encapsulating material is generally made of a plastic such as polyolefin, nylon, polyethylene terepthalate, polycarbonate, or other engineering thermoplastic resins. This encapsulating material covers at least a portion of the rim or flange and may extend a distance from the rim's outer edge. The exterior of the encapsulating material is substantially smooth, even those portions filling or overlying irregularities in the rim. Further, the encapsulated rim presents a hermetic barrier to gases and moisture, and may be sealed with a film or other material to completely insulate the container interior.

But the polymer used for the encapsulation is expensive and the amount used increases the cycle time required to form useful container bodies. Besides, the manufacturing process becomes complex.

To reduce the impact of the encapsulating of the rim on manufacturing costs and time, EP1485178 proposes to reduce the amount of polymer by encapsulating only a portion of the rim or flange. For example, only the underside of the rim is covered with the encapsulating material. By injecting resin only on the under or backside of the rim during the injection-molded process, the exposed paperboard pleats on the upper surface of the rim are pressed upwardly against a surface of the metal mold by the hot, high-pressure injectant, which compresses or “irons” the pleats on the upper surface of the flange. This creates an improved sealing surface on the upper side that helps ensuring that a hermetic seal is obtained across the now-flattened pleats. Moreover, the smooth surface of the encapsulated underside of the rim can also be bound to the lid while this latter is bent downwardly.

Nevertheless this solution still uses encapsulating material and injection of this material into a mold. So the manufacturing costs and time are reduced but only in a quite low extend. Besides, this solution does not come up to the consumers' expectations for more natural and recyclable products. Another solution that is disclosed in Billerud's WO 2015/082268 patent application, wherein the wrinkles created by the three-dimensional deformation of the paper layer of the container body, are reclosed by spraying or otherwise coating a material to “fill” the wrinkles before the top lid is sealed thereto. This solution has the drawback that it requires an additional component to the structure of the pod (i.e. the rim coating material) and also an additional spraying step and equipment which adds cost and complexity to the process.

Consequently, a need exists to develop a method for ensuring proper sealing of Paper/PLA laminates, that uses current manufacturing technologies and that does not add any additional container element.

### SUMMARY OF THE INVENTION

An object of the present invention is to provide a simpler and cost-saving manufacturing process for producing hermetic single-use food containers such as coffee pods. In particular, the object of the invention is to avoid the need for encapsulating, even partially, the rim of the pod.

The manufacturing method of the present invention also aims to obtain an efficient sealing on the rim of single-use food containers to ensure in-cup quality and adequate shelf-life through efficient oxygen and vapor barrier properties, even with a container body made from paper/PLA laminate.

In other words, an object of the invention is to provide a new nature-friendly pod with no encapsulated rim feature but which is at least as hermetic as the prior pods having encapsulated rim features.

To this end, the manufacturing process for producing hermetic single-use food containers according to the invention includes:
forming a container body having a peripheral upper rim,
placing the container body into a sealing head having a first die and a second die, at least one of which being mobile, the first die and the second die having cooperating annular sealing surfaces facing the rim,
applying a closing lid, such as a lid film, over the container body placed into the sealing head,
sealing the closing lid with the rim of the container body by applying the first die and the second die one against the other.

The process according to the invention is characterized in that the first die of the sealing head is provided with an annular rib in its sealing surface, the rib extending continuously essentially in a circumferential direction all around the sealing surface and having a height which is at least equal to a maximum depth of wrinkles that might appear on the rim upon forming the container body, whereby a continuous sealing groove is engraved by the rib in a side of the rim (all around the rim) when sealing the closing lid to the container body, the closing lid being bound to the rim in front of this sealing groove.

It is to be noted that, the sealing step in a process according to the invention can use heat-sealing or ultrasonic-sealing technics, whereby the sealing head can comprise heating elements or means for producing ultrasonic vibrations. Other types of sealing, for example induction sealing, are also possible.

Besides, in all the description, the “sealing surface” of a die refers to the surface of the die that contacts with, or more generally acts on, the lid or the container body during the sealing. This surface can have the same dimensions as the rim or can be smaller. Moreover, the sealing surfaces of the two dies might have different widths.

During the sealing, the rib of the first die flattens the wrinkles, erases the channels between the two membranes and produce one continuous sealing line.

Preferably, the rib height is less than the thickness of the container body.

Thanks to the rib of the first die of the sealing head according to the invention, the container body can be made from a sheet of paper/PLA laminate using a very simple manufacturing process, which can be summed up in a sealing stamping step with a very basic sealing head which is a mere heating or ultrasonic press with no injecting elements. The only specificity of the sealing head is the design of its sealing parts which includes a rib the height of which is higher than the depth of the wrinkles in the rim.

It is to be noted that in all the description, the term “a” means “at least one” (but not “one and only one”) unless otherwise mentioned. Thus, the first die may have two or more concentric ribs in its sealing surface.

Preferably, the sealing head is the head of a vertical press that is to say that the sealing head is arranged such that the mobile die is translated in a vertical direction (the sealing line is then in a horizontal plan), the sealing head having an upper die and a lower die.

In such a configuration, the first die (with the rib) can be the upper die, the second die being the lower die, whereby the sealing groove engraved by the rib is formed in the top side of the rim. Alternatively, the first die is the lower die, the second die being the upper die, and the sealing groove is formed in the underside of the rim.

The sealing surface of the second die can be flat, more specifically flat and rigid. Alternatively, the sealing surface of the second die can be provided with a sealing groove or with a rubber seat in front of the rib of the first die.

In a preferred embodiment, the first die is the lower die of a vertical press (the second die being the upper die) and the sealing surface of the second die is flat and rigid. Consequently, a sealing groove is formed by the rib in the underside of the rim whereas the top surface of the closing lid remains flat in front of the rim. Thus, if a reference code is printed on the top surface of the closing lid at the rim, this reference code is not distorted by the sealing process and the sealing groove in the underside of the rim does not disturb the reading of this reference code.

Preferably, the container body, the rim and the sealing surfaces of the sealing head have a circular section. In that case, the rib of the first die is also advantageously circular.

The invention also concerns the device used to perform the manufacturing process according to the invention. In particular, the invention concerns a sealing head for sealing a closing lid on a rim of a container body of a single-used food container, wherein the sealing head includes a first die and a second die, one of which being mobile, the first die and the second die having cooperating annular sealing surfaces that face the rim when the container body is placed in the sealing head. The sealing head is characterized in that the first die is provided with an annular rib in its sealing surface, the rib having a height which is at least equal to a maximum depth of wrinkles that might appear in the rim upon forming the container body.

In a preferred embodiment adapted for manufacturing pods such as coffee pods, the annular sealing surfaces of the dies and the rib of the first die are all circular.

In a preferred embodiment specifically suitable for manufacturing coffee pods made from a sheet of paper/PLA laminate, the height of the rib is at least equal to 0. 7 mm, preferably at least equal to 1 mm.

More generally, the height of the rib is preferably comprised between 0.1 mm and 4 mm, and the width of the rib is preferably comprised between 0.15 mm and 6 mm. Besides, the width of the rib is preferably less than three times the height of the rib.

The invention also concerns a hermetic single-use food container obtained by the manufacturing process according to the invention. In particular, the hermetic single-use food container includes a container body with a peripheral rim and a closing lid closing the container body. The hermetic single-use food container is characterized in that:
the container body is made in a paper-laminated material and have wrinkles at least at the rim, the wrinkles extending essentially radially,
it shows an annular sealing groove engraved on a side of the rim which extends continuously essentially in a circumferential direction all around the rim and which has a depth at least equal to a maximum depth of the wrinkles whereby the wrinkles are flattened by the sealing groove, the closing lid being bound to the rim of the container body at least in the region of the sealing groove.

As regards the first characterizing point above, the terms “paper-laminated material” means that the material constituting the container body includes several layers one of which is a paper sheet. Besides, the wrinkles are the result of the forming of the (3D) container body from a 2D blank of the paper-laminated material.

As regards the second characterizing point, a direct consequence of the sealing groove (by flattening the wrinkles) is that the top surface of the rim of the container body is flat in front of the groove and is therefore able to be hermetically bound to the closing lid in that region.

In a preferred embodiment, the closing lid has a top surface which is flat at least at the rim.

In a preferred embodiment, the sealing groove is engraved in an underside of the rim.

Preferably, the container body is made from a sheet of paper/PLA laminate.

In a more preferred embodiment, the container body is made from a sheet of PLA-PVOH-PLA of 50 μm laminated with a formable paper of 130 g/m² and the lid film is made from a sheet including a PLA barrier laminated with a paper of 30 g/m².

The sealing groove engraved in a side of the rim can have a height comprised between 0.05 mm and 3 mm, and a width comprised between 0.15 mm to 5 mm. Besides, the width of the sealing groove is preferably less than three times the height of the rib; more preferably, the width and the height of the sealing groove are equivalent.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic view in perspective of a container body according to the invention or to the prior art.

FIG. 2 is a schematic cross-section of single-use food container according to the invention.

FIG. 3 is a schematic cross-section of a forming device that can be used in a manufacturing process according to the invention.

FIG. 4 is a schematic cross-section of a portion of an embodiment of a sealing head according to the invention.

### DETAILED DESCRIPTION OF THE INVENTION

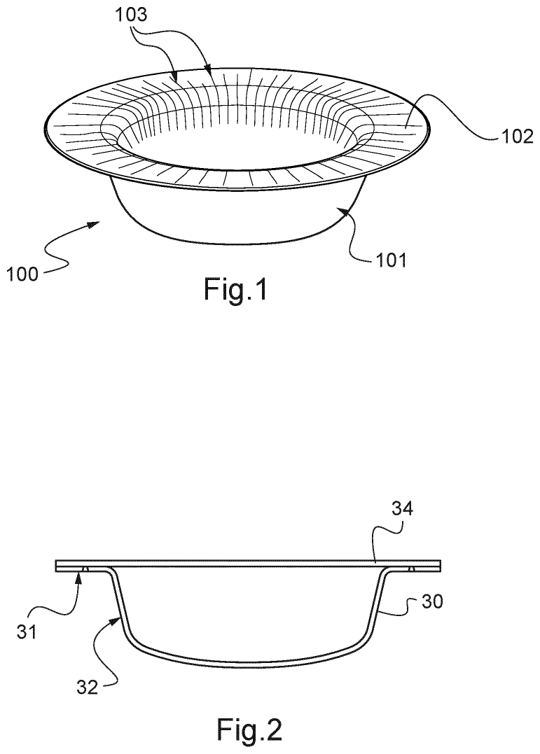

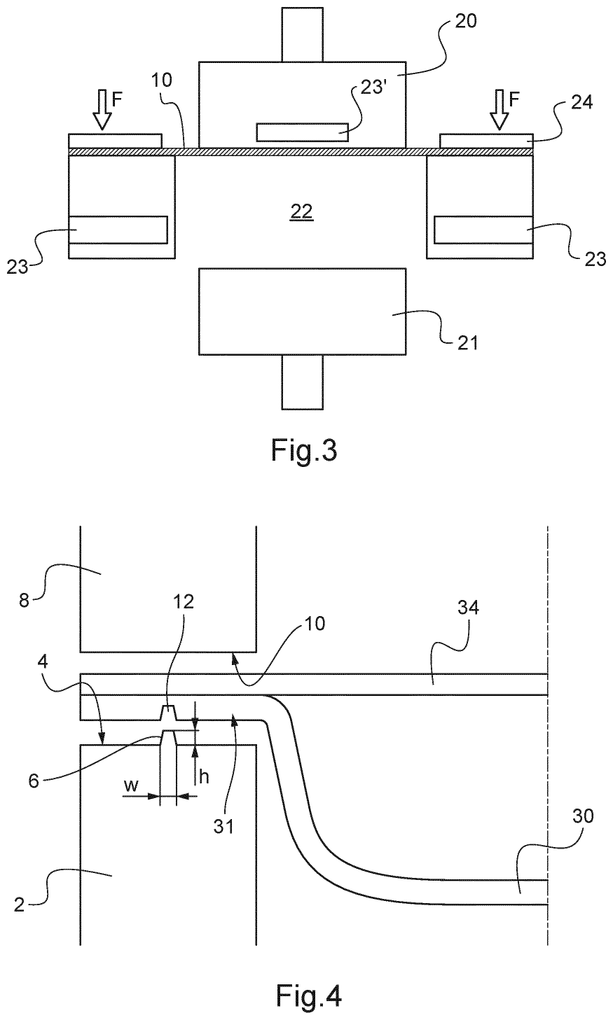

The first step of the manufacturing process according to the invention aims to produce a 3D container body such as the container body 100 shown at FIGS. 1 and 2, from a 2D blank 10 illustrated in FIG. 3. The forming process used in the manufacturing process according to the invention can be chosen from known sliding blank processes (where the sliding of the blank into the mould and the lateral contraction of the blank cause the micro-folding of the blank) such as stamping processes or deep-drawing processes, or from known fixed blank processes (where the container is formed essentially via straining of the blank) such as air forming/vacuum forming processes and hot pressing processes, depending on the desired shape (in particular the desired depth) for the container body, the material of the blank, etc.

For example, the forming of the container body can be carried on by deep-drawing with a press as illustrated at FIG. 3, comprising a male die 20 while the female mould can be absent, present as a counter holder 21 as illustrated or used to emboss the under of the shape. The 2D blank 10 is placed into the forming machine where it is clamped by a blank holder 24 with a predetermined force F; subsequently, the male die 20 starts a downward movement towards the counter holder 21 along a forming cavity 22, which is where the actual forming occurs. Finally, the shape is released from the forming device. The forming cavity is preferably surrounded by heating elements 23. Heating elements 23′ can also be provided in the male die 20.

The whole forming sequence can be as short as a couple of seconds. The selection of forming parameters such as the die force, the blank holding force F, the forming gap or clearance (which is the lateral distance between the edge of the forming cavity and the edge of the male die) is performed empirically.

As to the forming gap, it can be noted that this distance is varied, among others, according to the thickness of the material from which the blank is made. Too small a forming gap increases the out-of-plane and in-plane shear and forces. This can lead to the formation of cracks and eventual failure of material in the formed shape. Typically, the gap is around 0.7 times the thickness of the paperboard (it can be noticed that dimensions and ratios are not respected at FIG. 3, which is very schematic). On the other hand, too large a forming gap leads to the poor appearance of the shape and to significant wrinkles that create voids which restrict the possibility of gas-tight sealing of such shapes.

As a negative consequence of the forming process, the container body 100 exhibits wrinkles 103 (see FIG. 1) essentially in the rim 102 and at the junction between the rim 102 and the sidewall 101 and on a large part of the sidewall 101.

To close the container body thus obtained, a closing lid (not shown at FIG. 1) is later sealed on the upper surface of the rim 102 after the container body 100 has been filled with food. The wrinkles 103 compromise the perfect sealing of the closing lid with the rim and a hermetic seal cannot be obtained. In particular, the wrinkles formed at the surface of the rim are oriented in the radial direction of the container body 100, and their impair the correct flatness of the rim. Therefore, when the upper lid is sealed onto said rim, radial channels are created along the wrinkles, through which oxygen and moisture are able to circulate from outside the container, into the internal compartment of said container, hence rapidly degrading the quality of the food contained therein.

To solve this problem, the invention proposes to use a sealing head one die of which has a sealing surface with a specific profile. An example of a sealing head according to the invention is partially represented at FIG. 4 with a container body 30 and a closing lid 34 therein. The sealing head includes a fixed lower die (first die) 2 with an annular top sealing surface 4 and a movable upper die (second die) 8 with a bottom sealing surface 10, the cooperating sealing surfaces 4 and 10 being circular and having a width that corresponds to the width of the rim 31 of the container body 30.

The sealing surface 4 of the first die 2 includes a circular rib 6, while the sealing surface 10 of the second die 8 is flat (planar). The rib 6 causes a sealing groove 12 in the underside of the rim that erases the wrinkles (such wrinkles are not represented at FIG. 4). More precisely, the formation of the groove 12 in a direction which is orthogonal to the direction of the wrinkles, “flattens” and therefore recloses the wrinkles by pushing the material of the rim back into the empty space of each wrinkle. As a consequence, all wrinkles on the periphery of the rim are eliminated by deformation of the material, at least in the region of the groove. In a highly preferred embodiment of the invention, the groove is formed on the underside of the rim (as illustrated in FIG. 4), although the wrinkle-removing groove could be formed on the upper surface of the container rim. By forming the groove on the underside of the rim as shown in FIG. 4, the upper surface of the rim is preserved and more than that, the entire surface of said rim is in principle kept entirely flat. As a result, it is much easier to seal a top lid afterwards, preserving the seal integrity of the resulting container.

The rib 6 has dimensions h (height) and w (width) chosen such that the height of the sealing groove 12 engraved in the rim is comprised between 0.1 mm to 3 mm and the width of the sealing groove 12 is comprised between 0.15 mm to 5 mm. The dimensions of the rib 6 may be slightly higher than the dimensions of the desired sealing groove 12 depending on the elasticity of the material constituting the container body. Moreover, the width of the rib 6 is preferably less than three times its height. In any case, according to the invention, the height of the rib 6 and the height of the sealing groove 12 should be higher than a maximum depth of the wrinkles of the container body 30, the wrinkles depth depending, among others, on the dimensions, the material and the forming conditions of the container body.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. Manufacturing process for producing hermetic single-use food containers, including:
forming a container body having a peripheral rim,
placing the container body in a sealing head having a first die and a second die, at least one of which being mobile, the first die and the second die having cooperating annular sealing surfaces facing the rim,
applying a closing lid over the container body,
sealing the closing lid with the rim of the container body by applying the first die and the second die one against the other, and
the first die is provided with an annular rib in its sealing surface, the rib having a height which is at least equal to a maximum depth of wrinkles that might appear on the rim upon forming the container body, whereby a sealing groove is formed by the rib in a side of the rim when sealing the closing lid to the container body, the closing lid being bound to the rim in front of the sealing groove.

2. Manufacturing process according to claim 1, wherein the container body is made from a sheet of paper/PLA laminate.

3. Manufacturing process according to claim 2, wherein the container body is made from a sheet of PLA-PVOH-PLA of 50 μm laminated with a formable paper of 130 g/m² and wherein the closing lid is made from a sheet including a PLA barrier laminated with a paper of 30 g/m².

4. Manufacturing process according to claim 1, wherein the first die is a lower die of a vertical press and the second die is an upper die, whereby the sealing groove is engraved is in an underside of the rim.

5. Manufacturing process according to claim 1, wherein the sealing surface of the second die is flat and rigid.

6. Hermetic single-use food container, including a container body with a peripheral rim, and a closing lid closing the container body comprising:
the container body is made in a paper-laminated material and has wrinkles at least at the rim, the wrinkles extending essentially radially, and
the hermetic single-use container shows an annular sealing groove engraved on a side of the rim which extends continuously essentially in a circumferential direction all around the rim and which has a depth at least equal to a maximum depth of the wrinkles whereby the wrinkles are flattened by the sealing groove, the closing lid being bound to the rim of the container body at least in the region of the sealing groove.

7. Hermetic single-use food container according to claim 6, wherein the closing lid has a top surface which is flat at least at the rim.

8. Hermetic single-use food container according to claim 6, wherein the sealing groove engraved in the rim is formed in an underside of the rim.

9. Hermetic single use food container according to claim 6, wherein the sealing groove engraved in the rim has a width comprised between 0.15 mm and 5 mm, and a height of between 0.05 mm and 3 mm.

10. Hermetic single use food container according to claim 6, wherein the container body is made from a sheet of paper/PLA laminate.

11. Hermetic single use food container according to claim 10, wherein the container body is made from a sheet of PLA-PVOH-PLA of 50 μm laminated with a formable paper of 130 g/m² and wherein the closing lid is made from a sheet including a PLA barrier laminated with a paper of 30 g/m².

12. Coffee pod that includes a hermetic single-use food container including forming a container body having a peripheral rim, placing the container body in a sealing head having a first die and a second die, at least one of which being mobile, the first die and the second die having cooperating annular sealing surfaces facing the rim, applying a closing lid over the container body, sealing the closing lid with the rim of the container body by applying the first die and the second die one against the other, and the first die is provided with an annular rib in its sealing surface, the rib having a height which is at least equal to a maximum depth of wrinkles that might appear on the rim upon forming the container body, whereby a sealing groove is formed by the rib in a side of the rim when sealing the closing lid to the container body, the closing lid being bound to the rim in front of the sealing groove.
